(19) United States
(12) Patent Application Publication
(10) Pub. No.: US 2025/0389905 A1
(43) Pub. Date: Dec. 25, 2025

(54) Magnetic Latching Connector with Fiber Optic and Electrical Connections

(71) Applicant: Onanon, Inc., Milpitas, CA (US)

(72) Inventors: Dennis J. Johnson, Milpitas, CA (US); Keyon Keshtgar, Milpitas, CA (US); Emma G. Ruck, Milpitas, CA (US)

(21) Appl. No.: 18/747,825

(22) Filed: Jun. 19, 2024

(51) Int. Cl. G02B 6/38; H01R 13/58; H01R 13/62; H01R 13/631; H01R 13/635

(52) U.S. Cl. CPC G02B 6/3886; G02B 6/3817; G02B 6/3874; G02B 6/38875; H01R 13/5845; H01R 13/6205; H01R 13/631; H01R 13/635

(57) ABSTRACT

Magnetic latching connectors with fiber optic and electrical connections are disclosed herein. An example connector system includes a first housing component having a receptacle portion configured with a first plurality of electrical contact elements and a first plurality of fiber optic components, each fiber optic component including a ferrule assembly, a spring, and a back post, a second housing component having a plug housing, a printed circuit board assembly housing a second plurality of electrical contact elements, and a second plurality of fiber optic components, each fiber optic component including a ferrule assembly and a solid ferrule sleeve, and a magnetic coupling mechanism including a magnet associated with one of the first housing component or the second housing component, and a metallic element in an opposing one of the first housing component or the second housing component, for magnetically mating the first housing component and the second housing component.

### CROSS-REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

The present disclosure pertains to the field of electronic connectors, specifically to a magnetic latching connector that integrates fiber optic and electrical connectivity within a singular device, in order to streamline connections and enhance signal integrity in various electronic applications. 18

### SUMMARY

Some of the various embodiments of the present disclosure relate to a magnetic latching connector with fiber optic and electrical connections. An example connector system includes a first housing component having a receptacle portion configured with a first plurality of electrical contact elements and a first plurality of fiber optic components, each fiber optic component including a ferrule assembly, a spring, and a back post; a second housing component having a plug housing, a printed circuit board assembly housing a second plurality of electrical contact elements, and a second plurality of fiber optic components, each fiber optic component including a ferrule assembly and a solid ferrule sleeve; and a magnetic coupling mechanism including a magnet associated with one of the first housing component or the second housing component, and a metallic element in an opposing one of the first housing component or the second housing component, for magnetically mating the first housing component and the second housing component.

Implementations may include one or more of the following features. The connector system where the metallic element is a steel ring configured to align with and be attracted by the magnet to facilitate the magnetic mating. The springs of the fiber optic components of the first housing component are each configured to exert a force that maintains optical contact between the first plurality of fiber optic components and the second plurality of fiber optic components. The second housing component further may include an over-molded boot configured to enclose internal components within the plug housing and provide strain relief for an attached hybrid cable including electrical conductors and optical fibers. The first and second housing components include a complimentary keying feature to ensure proper alignment and orientation upon mating. The magnetic coupling mechanism is configured to automatically disengage the first and second housing components upon application of a force exceeding a predetermined threshold. The solid ferrule sleeves of the second housing component are configured to guide and align ferrule assemblies of the first housing component for optical connection upon mating.

One general aspect of the connector system includes a first housing component may include: a first array of electrical contact elements; a first fiber optic component may include a first ferrule assembly, a spring, and a back post. The system also includes a second housing component may include: a plug portion featuring an insulator, a printed circuit board assembly that accommodates a second array of electrical contact elements arranged for interfacing with the corresponding first array of electrical contact elements in the first housing component, and a second fiber optic component may include a second ferrule assembly and a solid ferrule sleeve designed for direct alignment with the first ferrule assembly. The system also includes a magnetic coupling mechanism may include a magnet located within the second housing component and a ferromagnetic element positioned in the first housing component, configured for enabling a magnetic engagement between the first and second housing components to facilitate both electrical and optical connectivity upon their coupling.

Implementations may include one or more of the following features. The connector system where the back post is configured to secure the spring and first ferrule assembly, the spring providing a force for the first ferrule assembly. The printed circuit board assembly of the second housing component is configured to facilitate signal processing and distribution among the first and second electrical contact elements. The hybrid cable includes both electrical conductors and optical fibers configured to transmit electrical and optical signals, respectively. The first and second fiber optic components are configured to support multimode fiber operation, enabling high bandwidth data transmission.

There have thus been outlined, rather broadly, some of the embodiments of the present disclosure in order that the detailed description thereof may be better understood, and in order that the present contribution to the art may be better appreciated. There are additional embodiments that will be described hereinafter and that will form the subject matter of the claims appended hereto. In this respect, before explaining at least one embodiment in detail, it is to be understood that the various embodiments are not limited in their application to the details of construction or to the arrangements of the components set forth in the following description or illustrated in the drawings. Also, it is to be understood that the phraseology and terminology employed herein are for the purpose of the description and should not be regarded as limiting.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless there is evidence to the contrary from the description, where elements in different figures use identical reference numbers, the elements are generally either identical or at least similar in function or purpose.

### BRIEF DESCRIPTION OF THE DRAWINGS

FIG. 1 is a perspective view of an electrical connector in accordance with an example embodiment.

FIG. 2 is an exploded view of a female connector of the electrical connector.

FIG. 3 is an exploded view of a male connector of the electrical connector.

FIG. 4 is a perspective view of the male and female connectors of the electrical connector.

FIG. 5 is a sectional view of the male and female connectors in a connected configuration.

FIG. 6 is another sectional view of the male and female connectors in a connected configuration.

### DETAILED DESCRIPTION

### A. Overview

The present disclosure pertains to a magnetic latching connector that combines fiber optic and electrical connectivity in a single unit. This device aims to solve the prevailing challenge in the connectivity domain, where traditional connectors require separate mechanisms and distinct physical interfaces for electrical and fiber optic connections. Such separation not only increases spatial requirements and manufacturing costs but also complicates the installation process, posing risks of misalignment and inconsistent connection quality.

The magnetic latching connector utilizes magnetic force to simplify the mating process between the connector halves, which not only enhances ease of use but also promotes a secure, but releasable connection. By integrating fiber optic components with electrical contacts, the connector supports a wider range of signal types and improves overall signal integrity. Its design incorporates a self-aligning feature that mitigates the risk of connection errors and reduces the need for manual adjustments.

Embodiments of the present disclosure include an array of electrical contacts and fiber optic components arranged within two housing devices-one female and one male. The female housing contains a metallic ring that interacts with a magnet in the male housing, allowing for a self-mating functionality that ensures a secure physical and signal connection. This magnetic mating also serves as a safety feature, as the connectors can disengage when exposed to excessive force, preventing damage to the connected devices.

The fiber optic components are configured to align with one another and maintain optical connectivity, ensuring optimal data transmission. The inclusion of springs allows for compliance in the connections, maintaining pressure and connection integrity even in the presence of vibrations or movement.

Magnetic latching, electrical, and fiber optic connectivity in one connector offer advantages by simplifying the connection process, enhancing signal transmission capabilities, and improving the robustness of the connection. The integrated design allows for more compact and efficient use of space within electronic systems, suitable for a wide range of applications from consumer electronics to complex industrial machinery.

### B. Example Connector

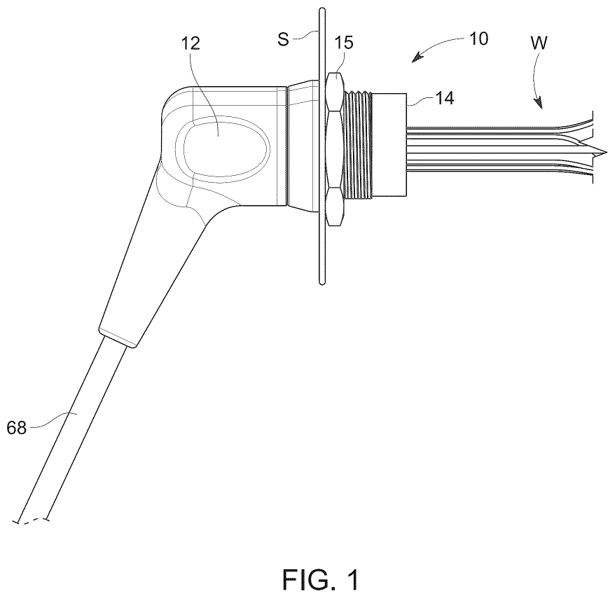

FIG. 1 is an isometric view of an example connector 10 that includes a male connector 12 and a female connector 14. Very broadly, the female connector 14 comprises internal recesses designed to accommodate protruding elements of the male connector 12. Within the female connector 14 are several apertures, which indicate electrical connectors intended for establishing an electrical connection. Additionally, the female connector 14 has optical connectors that align with corresponding optical connectors on the male connector 12 to facilitate fiber optic communication. The male connector 12 is tailored to match and interface with the female connector 14. The term connector can also be referred to as a housing component. A locking ring 15 can be used to secure the female connector 14 to a structure, such as a panel (not shown) of an electrical box. In some instances, the male connector 12 is connected to a hybrid cable 68 that includes both electrical and optical connectors. The female connector 14 is configured to couple with a structure, such as a sidewall S of an electrical panel (not shown). In some instances, wiring W (both electrical and optical) can be connected to the female connector 14. This wiring W is housed within the panel or structure S to which the female connector 14 is secured. The locking ring 15 can be threaded onto the female connector 14 and used to secure the female connector 14 to the structure S.

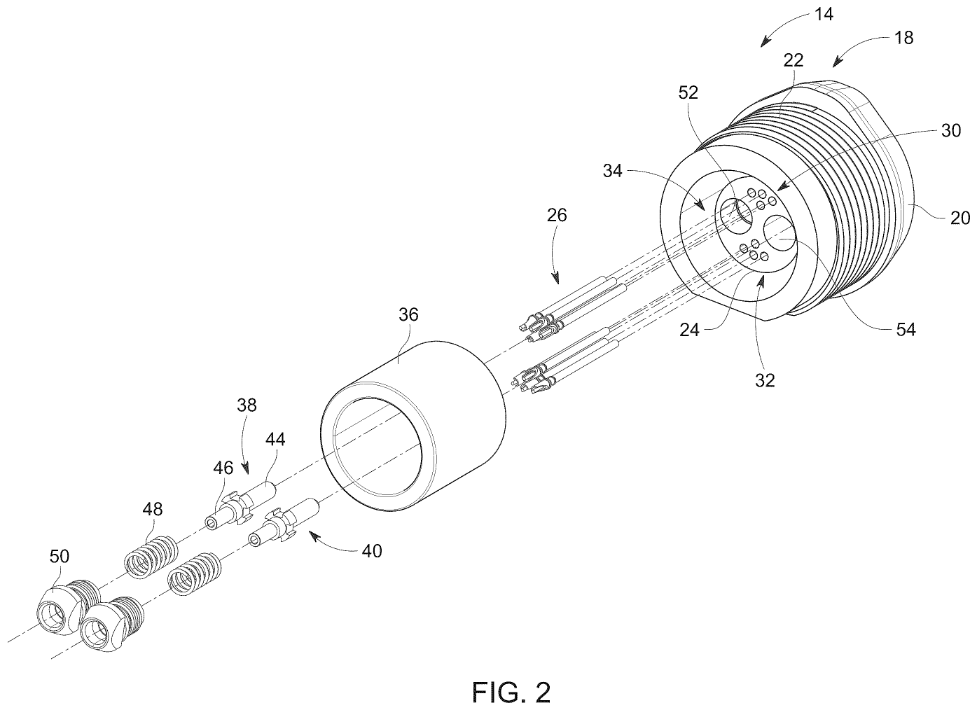

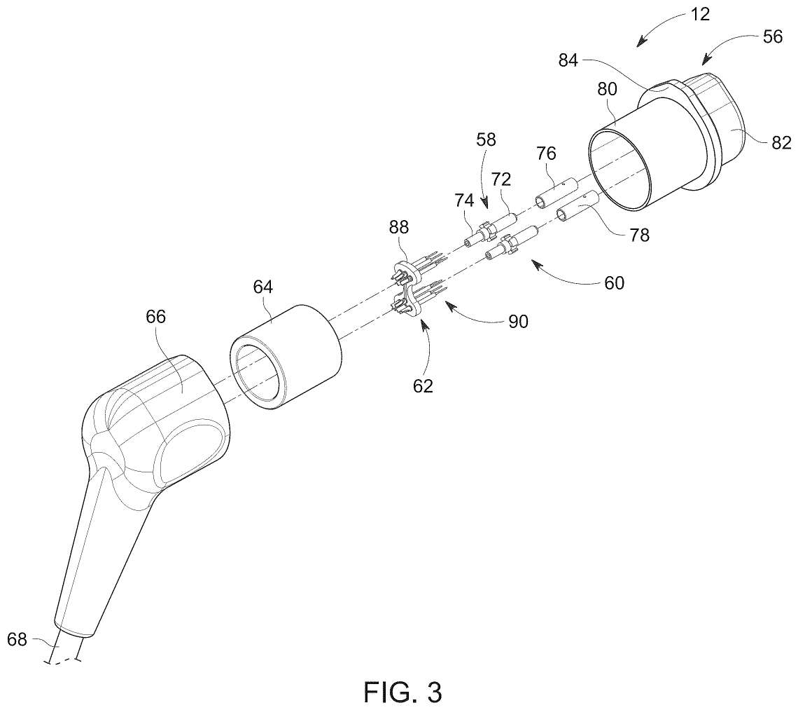

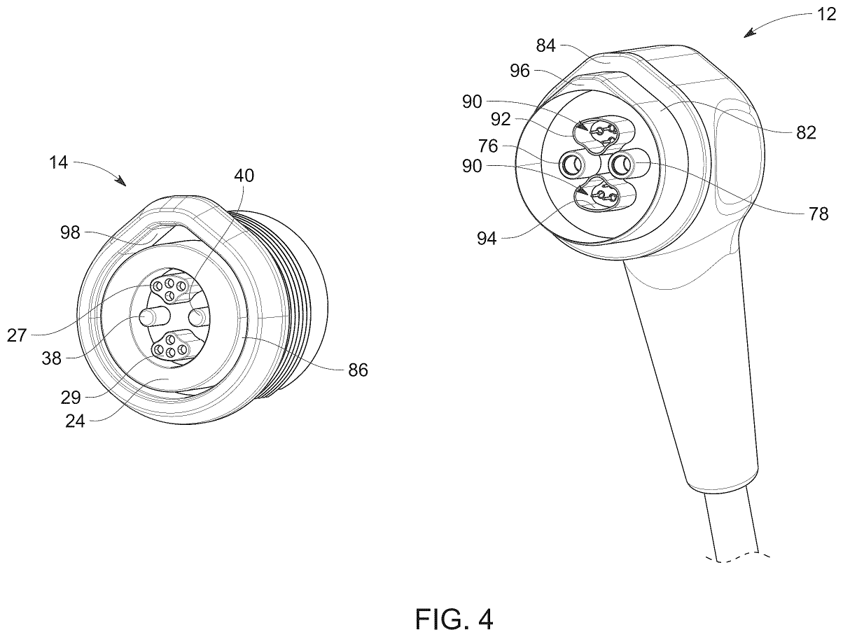

Referring now to FIGS. 2-4 collective, which include an exploded view of the female connector 14 (FIG. 2), an exploded view of the male connector 12 (FIG. 3), and a perspective view of the interfacing ends of the male connector 12 and the female connector 14 (FIG. 4). In one embodiment, the female connector 14 includes a receptacle housing 18 designed to safeguard internal components, crafted from a polymer for environmental resilience. The receptacle housing 18 can include an element providing a water-tight seal, such as a gasket or O-ring that can be positioned between the male connector 12 and the female connector 14. One of ordinary skill in the art will understand that the housing material can be selected from a wide variety of materials, depending upon the application, but in most instances will include any dielectric material.

The housing 18 has a body that includes a flange 20 with a threaded collar 22. An internal portion 24 of the body of the housing 18 has apertures for both electrical contacts and fiber optic components. In some instances, the electrical contacts are female pins. In this embodiment, four upper electrical contacts 26 are associated with four upper passthrough apertures 30 and four lower electrical contacts 26 are associated with four lower passthrough apertures 32. The number and arrangement of the electrical contacts can vary. The electrical contacts can be constructed of gold-plated copper for reliable conductivity and corrosion resistance. In some embodiments, the four upper electrical contacts 26 extend into an upper interface 27, and the four lower electrical contacts 26 extend into a lower interface 29. These upper and lower interfaces are each configured to be inserted into receptacles 92 and 94 formed in the male connector (see FIG. 4 and discussed below).

The electrical contacts 26 can electrically couple with electrical components, such as wiring in a panel to which the female connector 14 is affixed. That is, when the female connector 14 is installed on a structure, wiring from the structure can be coupled with the ends of the electrical contacts 26 that are opposite the ends that interface with the electrical contacts 26 of the male connector 12, as will be discussed in greater detail below.

A space 34 is created between the threaded collar 22 and the internal portion 24 of the body. This space 34 receives a portion of a metallic ring 36. In some embodiments, the metallic ring 36 is configured to attract a magnet on a male connector for self-mating functionality. 18

The housing 18 also comprises first fiber optic components 38 and 40, each one comprising a ceramic ferrule for aligning and transmitting optical signals, a spring, and a back post. In one example, the fiber optic component 38 includes a ferrule assembly having a ceramic ferrule 44 and metal housing 46. The fiber optic component 38 also includes a spring 48 and back post 50. To maintain the alignment and signal integrity, the spring 48 applies a consistent pressure to the ferrule assembly. The spring 48 can engage with protrusions of the metal housing 46 to move the ceramic ferrule 44 and ensure that it is compliant within the housing 18. Stability for the ferrule assembly is provided by back post 50, which secures the spring 48 and ferrule assembly within the housing. In some instances, the fiber optic components 38 and 40 fit into lateral apertures 52 and 54 of the internal portion 24. One variation of the back post 50 comprises a conical end defining an opening and threaded body that can be threaded into the lateral apertures 52 and 54 to secure the spring 48 and ferrule assembly inside the housing 18. In other embodiments, the back post 50 could include barbs or other similar protrusions that provide a press-fit or compression mating relative to the lateral apertures. Other methods and configurations for releasably securing the back posts into the lateral apertures that would be known to one of ordinary skill in the art can also be used, as long as such mechanisms are consistent with this disclosure and the functions of the devices disclosed herein.

Referring now to FIG. 3, the male connector 12 includes a plug housing 56, second fiber optic components 58 and 60, a PCB (printed circuit board) assembly 62, a magnetic element 64, an over-molded boot 66, and a hybrid cable 68. As with the embodiment above, the hybrid cable 68 includes both electrical and fiber optic components. In some instances, the printed circuit board is configured to facilitate signal processing and distribution among the first and second electrical contacts.

The second fiber optic components 58 and 60 are similar in structure to the first fiber optic components disclosed above (with respect to the female connector). In one example, the fiber optic component 58 includes a ferrule assembly having a ceramic ferrule 72 and metal housing 74. In some embodiments, the male connector 12 also includes ferrule sleeves 76 and 78, which include ceramic sleeves that guide and align the female connector's ferrule assemblies into contact with the male connector's ferrule assemblies. The solid ferrule sleeves 76 and 78 are configured to guide and align fiber optic components of the male connector 12 for optical connection upon mating.

An over-molded boot 66 covers the internal components of the male connector, providing strain relief for an attached hybrid cable 68 that contains both electrical contacts and optical fibers. In some instances, the plug housing 56 includes a first collar 80 and a second collar 82, with a flange 84 therebetween. The first collar 80 is configured to be inserted into the open end of the over-molded boot 66 and cover the internal components of the male connector 12, as well as contain the magnetic element 64. The second collar 82 is configured to be inserted into a groove 86 of the female connector 14 (see FIG. 4). In some instances, the magnetic element 64 is a rare earth magnet used to ensure a secure and reliable mating of the male and female connectors.

The PCB assembly 62 houses electrical components of the connector, and housing electrical contacts that facilitate the transmission of electrical signals. The PCB assembly 62 includes a body 88 that has arms that retain a second set of electrical contacts 90 as well as electrical leads of the hybrid cable 68 (not shown). In some instances, the electrical contacts 90 are placed into two groups of four elements (again, the number of connectors and their geometrical arrangement are not intended to be limiting). Referring again to FIG. 4, the ends of the electrical contacts 90 terminate inside receptacles 92 and 94 formed in the plug housing 56. The electrical contacts of the female connector 14 are inserted into the receptacles 92 and 94 of the plug housing 56, allowing the electrical contacts 26 of the female connector 14 and the electrical contacts 90 of the male connector to establish electrical connectivity therebetween. Also, and as best shown in FIG. 4, the male connector 12 and female connector 14 each include a keying feature 96 and 98 that allow for proper alignment between the male connector 12 and female connector 14.

The keying features 96 and 98 are areas of complementary geometrical irregularity that are configured to mate in such a way that the male and female connectors can only be joined in a particular orientation. In one example, the keying feature 96 of the male connector 12 includes a trapezoidal shaped protrusion formed in the second collar 82 of the male connector 12. This trapezoidal shaped protrusion fits inside a similar shaped notch formed in the groove 86 of the female connector 14.

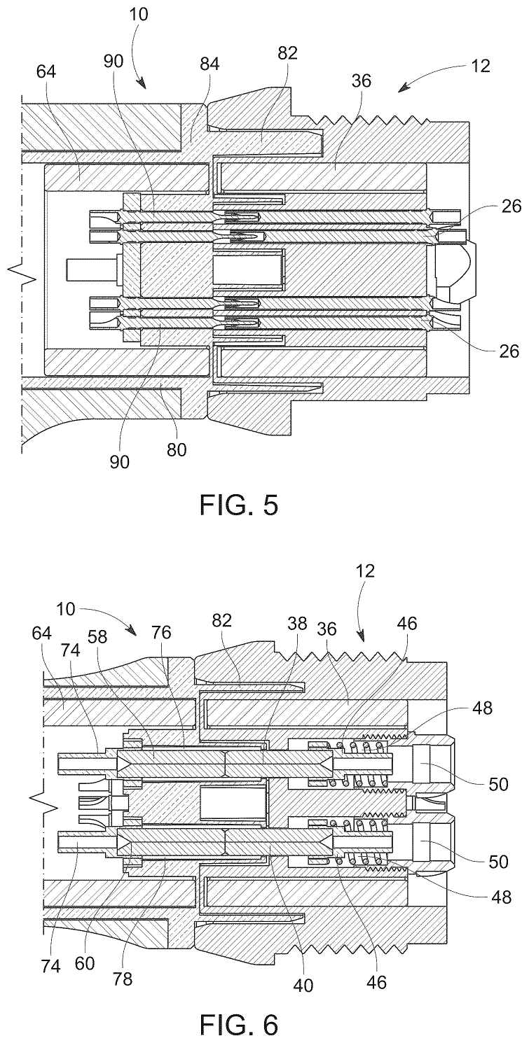

26 FIG. 5 is a sectioned view of a portion of the male and female connectors 12 and 14. In some instances, the electrical contact pins of the electrical contacts 90 of the male connector 12 are interfaced with the electrical contacts 26 of the female connector 14, when fully mated. In some instances, the electrical contacts 26 of the female connector 14 can have clips that interface with the electrical contact pins of the electrical contacts 90 of the male connector 12. In this state, the electrical contacts 90 and 26 are joined together, allowing the conductive elements to establish an electrical pathway and transfer electrical energy from one hybrid cable to the other hybrid cable. The metallic ring 36 of the female connector 14 and the magnetic element 64 of the male connector 12 are shown in an attracted state. In this view, the second collar 82 of the plug housing 56 is shown inserted into the groove 86 of the female connector 14.

FIG. 6 illustrates a sectioned view of the mated first and second connectors, which has been rotated to better illustrate the ferrules within the connectors when they are fully mated. In more detail, the ceramic ferrules of the first fiber optic components 38 and 40 are brought into contact with the ceramic ferrules of the second fiber optic components 58 and 60. The ceramic ferrules on the male connector 12 are static and can displace the movable ferrules on the female connector 14. The springs 48 exert force onto the female connector's ceramic ferrules 44 to ensure the ferrules (on both the male and female sides) are always touching when the male and female connectors are joined. In some instances, the fiber optic components are configured to support multimode fiber operation, enabling high bandwidth data transmission.

The connector system's design is versatile, allowing for various configurations to cater to specific requirements and applications. The design can be modified to include a different number, design, or layout of electrical pins, enabling the connector to be tailored for diverse electronic environments and increasing its adaptability to multiple electrical specifications.

Similarly, the system's flexibility extends to the fiber optic contacts. Adjustments can be made to the number and layout of these contacts to support various optical fiber types and signal transmission needs. This adaptability ensures the connector system can meet the bandwidth and data transmission demands of different optical networks.

The ferrules disclosed above can be varied in geometry, size, and the design of their metal housing. Such variations enable the connector to accommodate a range of fiber optic cable sizes and types, enhancing its compatibility with different fiber optic systems and improving its utility in a broader array of optical communication technologies.

In the realm of material science, the solid ferrule sleeve, a component used in the alignment and protection of fiber optics, can be constructed from different materials or designed differently. This allows the connector to offer enhanced performance characteristics, such as increased durability or improved signal integrity, tailored to specific use-case scenarios.

Alternative combinations of magnets and steel, such as magnet-to-magnet or swapping the locations of magnets and steel elements between the male and female 13 connectors, can provide varying magnetic strengths and disengagement characteristics, which could be useful for specific safety or usability requirements.

Also, the design of the printed circuit board (PCB) within the connector is configurable. The PCB can be reconfigured for different circuit layouts or electronic components, catering to varying electronic control functions or signal processing needs. This flexibility underscores the connector system's potential for customization, allowing it to integrate into an extensive array of electronic systems.

Also, the first and second fiber optic components of both the first and second housing components can include an anti-reflective coating to minimize signal loss and improve optical signal transmission efficiency. For the ferrule assemblies described, an example anti-reflective coating could be one made from materials such as magnesium fluoride (MgF2) or silicon dioxide (SiO2). These materials provide low refractive index, which reduces the reflection of light at the interface between the air and the fiber optic glass. The choice between these or other materials would depend on the specific wavelength of light used in the fiber optic system, as different materials optimize transmission at different wavelengths.

### C. Operation of Preferred Embodiment

Using the magnetic latching connector system is a simple process designed for ease and efficiency. To begin, you would have the male and female connectors 12 and 14 in hand. The female connector 14, typically panel-mounted, would be stationary, waiting for engagement. A user would take the male connector 12, which has a hybrid cable attached, and bring it close to the female connector.

Due to the magnetic coupling mechanism, as the male connector 12 approaches, the magnet within its housing is drawn towards the metallic steel ring within the female connector 14. This attraction guides the connectors into alignment without the need for precise manual handling. The keying features of the housings ensure that the connectors can only mate in the correct orientation, preventing any potential damage to the electrical connectors or fiber optic ceramic ferrules.

Once the male connector is close enough, the magnetic force will pull it into the female connector until they snap into a fully mated position. The electrical contacts 90 from the male connector 12 make contact with the electrical contacts 26 of the female connector 14, creating an electrical circuit. At the same time, the ferrule assemblies within both connectors align and come into contact, establishing the optical connection. The springs behind the female connector's ceramic ferrules 44 ensure constant pressure and maintain the 21 integrity of the optical signal. 22

To disconnect, the user can pull on the male connector 12, with a force exceeding the predetermined threshold of the magnetic coupling, to separate the male and female connectors. This feature is particularly useful in applications where a quick release is necessary for safety or convenience. Overall, the system's design for self-mating and automatic alignment simplifies the connection process, making it user-friendly and foolproof, reducing the risk of incorrect usage, and ensuring a reliable connection every time.

While various embodiments have been described above, it should be understood that they have been presented by way of example only, and not limitation. The descriptions are not intended to limit the scope of the technology to the particular forms set forth herein. To the contrary, the present descriptions are intended to cover such alternatives, modifications, and equivalents as may be included within the spirit and scope of the technology as defined by the appended claims and otherwise appreciated by one of ordinary skill in the art. The various embodiments of the present disclosure may be embodied in other specific forms without departing from the spirit or essential attributes thereof, and it is therefore desired that the various embodiments in the present disclosure be considered in all respects as illustrative and not restrictive. Thus, the breadth and scope of a preferred embodiment should not be limited by any of the above-described exemplary embodiments.

Unless otherwise defined, all technical and scientific terms used herein have the same meaning as commonly understood by one of ordinary skill in the art to which this invention belongs. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls. Any headings utilized within the description are for convenience only and have no legal or limiting effect.

What is claimed is:

1. A connector system comprising:
a first housing component having a receptacle portion configured with a first plurality of electrical contact elements and a first plurality of fiber optic components, each fiber optic component including a ferrule assembly, a spring, and a back post;
a second housing component having a plug housing, a printed circuit board assembly housing a second plurality of electrical contact elements, and a second plurality of fiber optic components, each fiber optic component including a ferrule assembly and a ferrule sleeve; and
a magnetic coupling mechanism including a magnet associated with one of the first housing component or the second housing component, and a metallic element in an opposing one of the first housing component or the second housing component, for magnetically mating the first housing component and the second housing component.

2. The connector system of claim 1, wherein the metallic element is a metal ring configured to align with and be attracted by the magnet to facilitate magnetic mating.

3. The connector system of claim 1, wherein the springs of the fiber optic components of the first housing component are configured to exert a force that maintains optical contact between the first plurality of fiber optic components and the second plurality of fiber optic components.

4. The connector system of claim 1, wherein the second housing component further comprises an over-molded boot configured to enclose internal components within the plug housing and provide strain relief for an attached hybrid cable comprising electrical wires and optical fibers.

5. The connector system of claim 1, wherein the first and second housing components include a complementary keying feature to ensure proper alignment and orientation upon mating.

6. The connector system of claim 1, wherein the magnetic coupling mechanism is configured to automatically disengage the first and second housing components upon application of a force exceeding a predetermined threshold.

7. The connector system of claim 1, wherein the ferrule sleeves of the second housing component are configured to guide and align ferrule assemblies of the first housing component for optical connection upon mating.

8. A connector system, comprising:
a first housing component comprising:
a first array of electrical contact elements;
a first fiber optic component comprising a first ferrule assembly, a spring, and a back post; and
a second housing component comprising:
a plug housing featuring an insulator;
a printed circuit board assembly that accommodates a second array of electrical contact elements arranged for interfacing with the corresponding first array of electrical contact elements in the first housing component, and a second fiber optic component comprising a second ferrule assembly and a solid ferrule sleeve designed for direct alignment with the first ferrule assembly; and
a magnetic coupling mechanism comprising a magnet located within the second housing component and a magnetic element positioned in the first housing component, configured for enabling a magnetic engagement between the first and second housing components to facilitate both electrical and optical connectivity.

9. The connector system of claim 8, wherein the magnetic element is a metal ring configured to align with and be attracted by the magnet to facilitate magnetic mating, and the springs of the fiber optic components of the first housing component are configured to exert a force that maintains optical contact between the first fiber optic component and the second fiber optic component.

10. The connector system of claim 8, wherein the back post is configured to secure the spring and first ferrule assembly, the spring providing a force for the first ferrule assembly.

11. The connector system of claim 8, wherein the printed circuit board assembly of the second housing component is configured to facilitate signal processing and distribution among the first and second electrical contact elements.

12. The connector system of claim 8, further comprising a hybrid cable attached to the second housing component, wherein the hybrid cable includes both electrical conductors and optical fibers configured to transmit electrical and optical signals, respectively.

13. The connector system of claim 8, wherein the first and second fiber optic components are configured to support multimode fiber operation, enabling high bandwidth data transmission.

14. The connector system of claim 8, wherein the electrical contact elements of the first and second housing components are gold-plated to ensure high conductivity and corrosion resistance.

15. The connector system of claim 8, wherein the magnetic coupling mechanism is a rare earth magnet used to ensure a secure and reliable mating of the first and second housing components.

16. The connector system of claim 8, further comprising a locking mechanism integrated into the first and/or second housing component, configured to mechanically secure a mated position in addition to the magnetic coupling.

17. The connector system of claim 8, wherein the magnetic coupling mechanism is configured to automatically disengage the first and second housing components upon application of a force exceeding a predetermined threshold.

18. The connector system of claim 8, wherein a receptacle portion of the first housing component comprises a water-resistant seal.

19. The connector system of claim 8, wherein the first and second fiber optic components of both the first and second housing components include anti-reflective coatings to minimize signal loss and improve optical signal transmission efficiency.

20. The connector system of claim 8, wherein the first and second fiber optic components each include a ceramic ferrule and a metal housing.
